(19) United States
(12) Patent Application Publication
(10) Pub. No.: US 2024/0318871 A1
(43) Pub. Date: Sep. 26, 2024

(54) RECEIVING DEVICE FOR SOLAR RADIATION WITH A CONTAINER FOR HEATING A HEAT TRANSFER MEDIUM IN A SOLAR THERMAL POWER PLANT

(71) Applicant: DEUTSCHES ZENTRUM FÜR LUFT- UND RAUMFAHRT E.V., 53227 Bonn (DE)

(72) Inventors: Johannes CLAR, Bad Bodenteich (DE); Jens RHEINLÄNDER, Mengelrode (DE)

(73) Assignee: DEUTSCHES ZENTRUM FÜR LUFT- UND RAUMFAHRT E.V., 53227 Bonn (DE)

(21) Appl. No.: 18/576,253

(22) PCT Filed: Jul. 5, 2022
(86) PCT No.: PCT/EP2022/068614

§ 371 Date: Jan. 3, 2024

(30) Foreign Application Priority Data
Jul. 7, 2021 (DE) 10 2021 117 606.9

(51) Int. Cl. F24S 20/20; F24S 40/80

(52) U.S. Cl. CPC F24S 20/20; F24S 40/80; F24S 2020/23

(57) ABSTRACT

A receiving device for solar radiation with a container for heating a heating transfer medium in a solar thermal power plant includes a double-walled housing which extends in a longitudinal direction, the housing surrounding an interior and having an outer wall and an inner wall surrounded by the outer wall, between which a plurality of support elements and counter support elements is disposed, wherein support elements and/or counter support elements corresponding with each other extend away from the outer wall and/or the inner wall in a radial direction, support elements and counter support elements corresponding with each other in at least the longitudinal direction are seated against each other on one side, and support elements and counter support elements corresponding with each other in the peripheral direction along at least one peripheral line are seated against each other on one side.

### BACKGROUND AND SUMMARY

The invention relates to a receiving device for solar radiation with a container for heating a heat transfer medium in a solar thermal power plant.

Prior art solar radiation receiving devices are known as solar particle receivers for solar tower power plants. Such receiving devices use a rotating hollow cylindrical container in which a closed film of ceramic particles with a diameter of typically 1 mm or smaller forms as a heat transfer medium on the inner wall of the rotating cylinder. This particle film is heated to over 1000° C. using concentrated solar radiation and then removed from the cylinder. The energy stored in the particles can be temporarily stored in an insulated container and used for power generation and/or in process applications.

DE 102014106320 A1 describes a device with a solar radiation receiver, which includes a container that includes an outer wall and an interior space surrounded by the outer wall.

The device comprises a supply device for supplying a heat transfer medium to the interior of the container. The container can be rotated about an axis of rotation by means of a rotary drive device of the solar radiation receiving device in such a way that the heat transfer medium is guided along an inner wall of the container to form a heat transfer medium film. The device comprises at least one overflow element to form a rotationally symmetrical inner surface of the heat transfer medium film.

DE 102010063116 A1 describes a device with a solar radiation receiver, which comprises a container that comprises an outer wall and an interior space surrounded by the outer wall. The interior accommodates a heat transfer medium, wherein solar radiation and/or heat transfer medium heated by solar radiation can be coupled into the interior via a coupling opening. The container rotates about its axis by means of a rotary drive device, wherein receiving regions for heat transfer medium are arranged or formed on the wall facing the interior. At least one driver is assigned to a receiving region, through which heat transfer medium can be taken along, when the container rotates in the direction of gravity.

It is desirable to create a cost-effective and maintenance-friendly receiving device for solar radiation with a container for heating up a heat transfer medium in a solar thermal power plant.

According to one aspect of the invention, a receiving device for solar radiation with a container for heating a heat transfer medium in a solar thermal power plant is proposed, comprising a double-walled housing which extends in a longitudinal direction, the housing surrounding an interior and having an outer wall and an inner wall surrounded by the outer wall, between which a plurality of support elements and counter support elements are disposed.

Support elements and/or counter support elements corresponding with each other extend away from the outer wall and/or the inner wall in a radial direction. Support elements and counter support elements corresponding with each other are seated against each other on one side in at least the longitudinal direction and in the peripheral direction along at least one peripheral line. There are at least two support elements which are seated against opposite sides of the respective corresponding counter support element. Alternatively or additionally, there are at least two counter support elements which are seated against opposite sides of the corresponding support element in question.

The container of the receiving device can, for example, be designed as a rotating drum in which a closed film of ceramic particles with a diameter typically of at most 1 mm is formed on the inner wall of the rotating cylinder. This particle film is heated to over 1000° C. using concentrated solar radiation and then removed. Temperatures of, for example, 1100° C. and more can occur.

The energy stored in the particles can be temporarily stored in an insulated container and used for power generation and/or in thermal process applications. The receiving device has an inlet for supplying the heat transfer medium to the container and an outlet for discharging the heat transfer medium from the container.

The rotating drum places special demands on the structure and support of the components. On the inner wall along which the particles are guided, the running surface for the particles, which is typically made of a high-temperature alloy, has a temperature of at least 900° C.

As a result, this metal surface, also called inliner, experiences large thermal expansions in the axial and radial directions. There is usually thermal insulation between the hot running surface of the inner wall and the outer wall of the container so that the energy flows to the outer wall are reduced and the outer wall is usually a maximum of 100° C. This means that there are lower thermal expansions on the outer wall.

Conveniently, some of the support elements and the corresponding counter support elements are now arranged alternately on the inner wall or the outer wall in such a way that they act as floating supports which are movably arranged to each other in the radial and axial direction and block a relative movement in the peripheral direction.

A further part of the support elements and the corresponding counter support elements is arranged alternately on the inner wall and the outer wall in such a way that they act as a further floating bearing which are movably arranged to each other in the radial and axial direction of the container and block a relative movement in the longitudinal direction of the container.

The two floating supports act perpendicular to each other. The interaction of the two types of floating supports, especially in the same location, forms a fixed support. This allows a relative movement of the support elements and counter support elements in the radial direction, but blocks it in the peripheral direction and in the longitudinal direction.

In this way, rotation of the inner wall about the longitudinal axis against the outer wall is blocked in the region of the support elements arranged as floating supports and corresponding counter support elements.

A fixed support can be provided, for example, in a peripheral region of the container, for example closer to one end of the container. In the region of the support elements arranged as a further floating support and corresponding counter support elements, which form a fixed support with the first type of floating support, a relative movement of the inner wall against the outer wall in the longitudinal direction as well as a rotation of the inner wall about the longitudinal axis against the outer wall is blocked on a peripheral line.

Differences in expansion between the inner wall and the outer wall can advantageously be compensated for by the support structure. At the same time, it is ensured that the inner wall has the same axis of rotation as the outer wall and does not slip through the outer wall in the longitudinal direction.

The support of the inner wall relative to the outer wall by means of the support elements and counter support elements according to an aspect of the invention represents a comparatively cost-effective way of positioning and supporting the two components. The container can therefore be manufactured and assembled in a cost-effective manner. The structure of the container also has an advantageous effect with regard to possible maintenance processes, since the container can be dismantled again in a relatively simple manner.

The receiving device with the container can be used advantageously for solar particle centrifugal receivers for solar power plants, solar process heat systems and solar chemical modification of particulate materials. Alternative, similar applications in which a hot inner tube is to be held in a cold outer jacket can also be implemented in a cost-effective manner.

The container can advantageously be made of steel. Due to the high temperatures of the heat transfer medium, the inner wall is advantageously made of a high-temperature-resistant stainless steel or another high-temperature alloy such as Inconel.

According to an advantageous embodiment of the receiving device, the support elements can be designed as fins projecting in the radial direction to the outer wall, which have at least one contact surface facing a corresponding counter support element in the peripheral direction. Alternatively or additionally, the counter support elements can be designed as fins projecting in the radial direction towards the inner wall, which have at least one contact surface facing the respective corresponding support element in the peripheral direction.

A floating support of the inner wall relative to the outer wall can be achieved by arranging individual fins of this type on the inner wall as support elements over the circumference of the inner wall. These fins can, for example, be drawn over the entire axial length or can be arranged individually, divided several times over the axial length. These fins serve as a sliding surface in the radial and axial directions. Drivers can be arranged alternately on the sliding surfaces in the axial direction, which are attached to the outer wall as counter support elements. Such an arrangement can also take place reciprocally in the peripheral direction. However, this is not absolutely necessary.

Since the floating support is arranged flat in this way, its functionality for blocking rotation of the inner wall against the outer wall in the direction of rotation is automatically also provided in the region of the fixed support. Consequently, it is sufficient if movement is only blocked in the longitudinal direction at the fixed support, i.e. in the region of two floating supports, one of which acts in the longitudinal direction and the other in the peripheral direction. The implementation can take place in such a way that, for example, a web, like a kind of stiffening ring, is arranged over the circumference of the inner wall. This ring can again be designed in the form of several individual fins, but this time oriented in the peripheral direction. The ring again serves as a sliding surface, this time only in the peripheral direction. Counter support elements can be arranged to slide alternately on this ring over the circumference, so that axial movement of the inner wall against the outer wall is hindered. The counter support elements are also connected to the outer wall.

However, for a fixed support in the longitudinal direction, a one-sided attachment of the counter support elements in the direction of gravity can also be sufficient. The construction in the so-called fixed support region can therefore be made more compact.

According to a favorable embodiment of the receiving device, a sliding element, in particular made of ceramic, can be arranged between at least one support element and the corresponding counter support element. In particular, the sliding element can be arranged on the support element. Additional ceramic plates can be installed on the contact surfaces to protect the material.

This means that the abrasion of the material due to the movement of the support elements and counter support elements due to the thermal expansion can be significantly reduced. In addition, the sliding element can also be easily replaced if necessary, for example due to abrasion. The sliding element can also act as thermal insulation.

Ceramic plates, for example made of Al₂O₃, SiC, ZrO₂, can be used as the material for the sliding element.

According to a favorable embodiment of the receiving device, an insulating element for thermal insulation can be arranged between the sliding element and the contact surface. Intermediate layers as thermal insulation between the sliding element and the support elements can significantly reduce the heat transfer from the inner wall to the outer wall. This makes it possible to maintain the lower temperatures required on the outer wall. The thermal loss of the receiving device can also be reduced to a required level in a favorable manner.

According to a favorable embodiment of the receiving device, the counter support elements can have a driver projecting in the radial direction, which has at least one contact surface facing a corresponding support element. The driver with its contact surface represents the active element of the counter support element for interaction of the support element and the counter support element to limit the relative movement of the inner wall against the outer wall. By means of the driver, the counter support element is seated on the support element via its contact surface.

According to a favorable embodiment of the receiving device, a sliding element, in particular made of ceramic, can be arranged on the contact surface of the driver, which faces the corresponding support element, in particular the respective sliding element. This means that the abrasion of the material due to the movement of the support elements and counter support elements due to the thermal expansion can be significantly reduced. The sliding element can also act as thermal insulation.

According to a favorable embodiment of the receiving device, at least one of the sliding elements can have a surface which is concavely curved in the radial direction and faces the respective corresponding sliding element. The concave curved surface of the sliding element facilitates assembly of the container by self-centering support elements and counter support elements in this way. In addition, movements of the inner wall against the outer wall due to thermal expansion, which can lead to shrinking and growing of the diameter of the inner wall, can be promoted.

According to a favorable embodiment of the receiving device, the counter support elements can have two legs, which are arranged in particular at right angles to one another, wherein one of the two legs has a connecting surface with the outer wall and the other of the two legs has the contact surface. In this way, the functions of connecting the counter support element to the outer wall and of realizing the driver as the actual support can be represented favorably. Production of the counter support element can thus be made cost-effective.

According to a favorable embodiment of the receiving device, the two legs of the counter support element can be connected by a strut, in particular arranged diagonally between the ends of the legs. The strut can serve as additional stiffening of the counter support element in order to be able to transmit larger forces between the support element and the counter support element.

According to a favorable embodiment of the receiving device, the two legs of the counter support element can be formed as U-profiles. The design as a U-profile can advantageously serve to be able to transmit larger forces between the support element and the counter support element. In addition, the counter support elements can be manufactured cost-effectively.

According to a favorable embodiment of the receiving device, the sliding elements and/or the insulating element can be connected to the respective support element or the respective counter support element by means of at least a fastening element, in particular a fastening spring.

Sliding elements and/or insulating elements can thus be reliably and permanently connected to the support element or counter support element by means of a fastening according to a tongue and groove concept. Due to the thermal stretching of the inner wall and the outer wall, shearing forces can also be conveniently absorbed between each other.

According to a favorable embodiment of the receiving device, a peripheral ring arranged radially between the outer wall and the inner wall can be formed along the peripheral line, which ring has or forms at least one support element. In particular, the ring can be arranged on the inner wall.

The implementation can be in such a way that, for example, a web, like a kind of stiffening ring, is arranged over the circumference of the inner wall. This ring can again be designed in the form of several individual fins oriented in the peripheral direction. The ring serves as a sliding surface in the peripheral direction. Counter support elements can be arranged to slide alternately on this ring over the circumference, so that axial movement of the inner wall against the outer wall is hindered.

According to a favorable embodiment of the receiving device, the inner wall can be formed from individual longitudinal segments joined together in the peripheral direction, in particular longitudinal segments arranged in a ring shape in the peripheral direction and stacked in the longitudinal direction, wherein the support elements are formed in one piece with the longitudinal segments. In particular, the support elements can be formed by folding the longitudinal segments along joining lines of the longitudinal segments relative to one another. By dividing the inner wall into individual longitudinal segments, large dimensions of the container can be realized inexpensively.

In particular, the integration of the support elements into the longitudinal segments by folding the longitudinal segments enables cost-effective production of the container. In addition, a firm connection of the support elements to the inner wall can be ensured in a simple manner.

According to a favorable embodiment of the receiving device, the longitudinal segments can be divided into axial segments in the longitudinal direction. The further subdivision of the longitudinal segments into axial segments facilitates the realization of large container dimensions. A cost-effective production of the container can thus be advantageously implemented.

According to a favorable embodiment of the receiving device, the longitudinal segments and/or axial segments can have stiffening ribs on a radial outer side, in particular diagonally extending stiffening ribs. Through the stiffening ribs, the mechanical stability of the inner wall can be significantly increased. This means that large dimensions of the container can be advantageously implemented while having a moderate increase in weight of the receiving device.

According to a favorable embodiment of the receiving device, at least the outer wall can be formed from flat longitudinal segments, which are joined at least along joining lines formed in the longitudinal direction.

A polygonal outer shape of the outer wall can prove to be particularly advantageous in order to have flat surfaces on the outside of the container for connecting the counter support elements. For example, the counter support elements can be mounted through a type of removable window. However, such windows can in principle also be formed by a cylindrical outer wall.

The advantage of constructing the outer wall from flat longitudinal segments is that many simple identical parts can be used. Since the support is sliding and therefore has several parts, assembly and subsequent maintenance are significantly simplified. Furthermore, the components are subject to a significantly lower load, as there will be no constant deformation due to sliding, in contrast to a version with a double spring. This means that large thermal deformation paths are possible without any problems.

A polygonal-shaped outer wall has the advantage that mechanical connections are possible in a simpler way. This also favors a multi-part structure for large containers.

According to a favorable embodiment, the receiving device can comprise an aperture opening for the entry of solar radiation at one of the ends of the container, the container having a longitudinal axis which is oriented parallel or at an acute angle less than or equal to 90° to the direction of gravity. The container can be rotated about an axis of rotation in the intended direction of rotation by means of a rotary drive device in such a way that the heat transfer medium can be guided along an inner wall of the container to form a heat transfer medium film.

By means of such an arrangement, a heat transfer medium film can be formed particularly favorably on the inner wall of the rotating container, so that the most uniform possible heat transfer from the solar radiation entering through the aperture opening to the heat transfer medium can be achieved.

Advantageously, a homogeneous distribution of the heat transfer medium, which can in particular be designed as a particle flow, can be achieved at the beginning of the running surface of the heat transfer medium on the inner wall of the container. The more homogeneous the particle film is over the entire height of the inner wall, the more efficiently and evenly the particles are heated by solar radiation.

### BRIEF DESCRIPTION OF THE DRAWINGS

Further advantages will be apparent from the following description of the drawings. Exemplary embodiments of the invention are shown in the figures. The figures, the description, and the claims contain numerous features in combination. A person skilled in the art will expediently also consider the features individually and combine them into further meaningful combinations.

In the exemplary figures:

FIG. 1 shows a receiving device for solar radiation with a container for heating a heat transfer medium in a solar thermal power plant in a transparent representation;

FIG. 2 shows an inner wall of the container with support elements arranged thereon and counter support elements according to a first exemplary embodiment of the invention in an isometric view;

FIG. 3 shows an inner wall of the container with support elements arranged thereon and counter support elements according to a first exemplary embodiment of the invention in an isometric view;

FIG. 4 shows a detail of a series of support elements and counter support elements according to the second exemplary embodiment of the invention from FIG. 3;

FIG. 5 shows a container with an inner wall and an outer wall according to a third exemplary embodiment of the invention in a sectioned isometric view;

FIG. 6 shows an enlarged detail of the container with inner wall and outer wall according to the third exemplary embodiment of the invention from FIG. 5;

FIG. 7 shows an inner wall of the container with support elements arranged thereon and counter support elements according to the third exemplary embodiment of the invention in an isometric view;

FIG. 8 shows a detail of a series of support elements and counter support elements according to the third exemplary embodiment of the invention;

FIG. 9 shows an enlarged view of the third exemplary embodiment with a view of sliding elements;

FIG. 10 shows an enlarged view of the third exemplary embodiment with a view of sliding elements and insulating elements;

FIG. 11 shows an enlarged view with a view of a fastening spring of a sliding element on a support element arranged on the inner wall;

FIG. 12 shows an enlarged view with a view of a fastening spring of a sliding element on a counter support element;

FIG. 13 shows an arrangement of support elements and counter support elements of the third exemplary embodiment designed as a fixed support in an isometric view;

FIG. 14 shows an arrangement of a counter support element of the third exemplary embodiment on the outer jacket;

FIG. 15 shows a counter support element according to the third exemplary embodiment of the invention in an isometric view with a view of the sliding element;

FIG. 16 shows the counter support element according to FIG. 15 with a view of the fastening spring of the sliding element;

FIG. 17 shows the counter support element according to FIG. 15 without the sliding element; and

FIG. 18 shows a container with a polygon-shaped outer jacket according to a further exemplary embodiment of the invention.

### DETAILED DESCRIPTION

In the figures, identical or identically acting components are identified by the same reference numerals. The figures only show examples and are not to be understood as restrictive.

Directional terminology used in the following with terms such as “left”, “right”, “above”, “below”, “in front of”, “behind”, “after”, and the like only serves for better comprehension of the figures and is in no way intended to restrict the generality. The components and elements shown, their design and use can vary according to the considerations of a person skilled in the art and can be adapted to the respective applications.

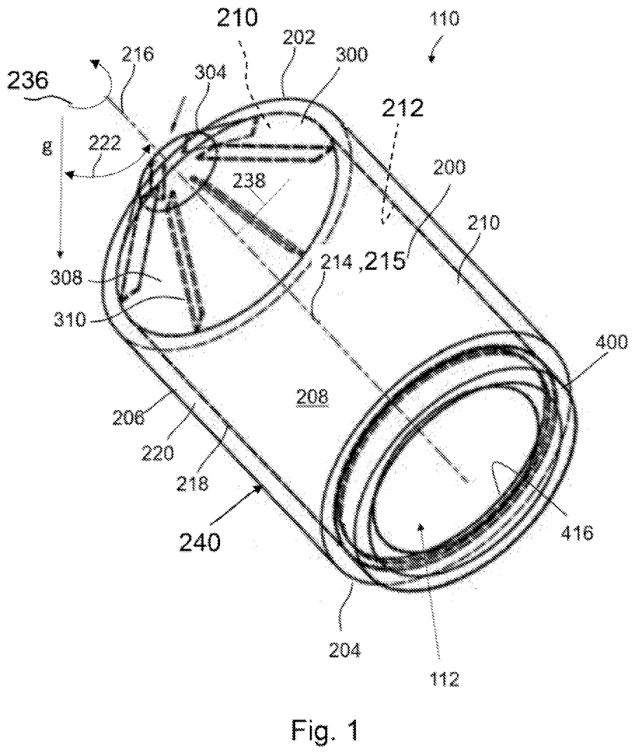

FIG. 1 shows a receiving device 110 for solar radiation with a container 200 for heating a heat transfer medium 210 in a solar thermal power plant in a transparent representation.

The known receiving device 110 shown in FIG. 1 comprises a container 200, which can be rotated about an axis of rotation 216 by means of a rotary drive device (not shown), as well as an inlet 300 for supplying the heat transfer medium 210 to an interior space 208 of the container 200 and an outlet 400 for discharging the heat transfer medium 210 from the container 200, both of which are connected to this container 200.

The container 200 has a longitudinal axis 214, which is oriented parallel or at an acute angle of typically less than or equal to 90° to the direction of gravity g, which is symbolized in the figure by a vertical arrow.

The container 200 in particular comprises a hollow cylindrical base body, which includes the circular cylindrical interior space 208 surrounded by an outer wall 206. An inner wall 218 is arranged at a distance from the outer wall 206 and surrounds the interior space 208.

The container 200 has thermal insulation between the outer wall 206 and the inner wall 218, so that temperatures of approximately 100° C. can be maintained on the outer side 240 of the container 200, although the temperature of the inner wall 218 can be, due the heated heat transfer medium 210, at least 900° C. or higher, for example 1100° C.

The receiving device 110 has an aperture opening 416 for the entry of solar radiation 112 at the lower end 204 of the container 200.

The container 200 can be rotated about an axis of rotation 216 in the intended direction of rotation 236 by means of a rotary drive device in such a way that the heat transfer medium 210 can be guided along the inner wall 218 of the container 200 to form a heat transfer medium film 212. The heat transfer medium 210 and the heat transfer medium film 212 are only indicated in FIG. 1 on the side of the inner wall 218 facing the interior space 208.

The axis of rotation 216 encloses an angle 222 with the direction of gravity g, which can lie between 0° and 90° and can typically be approximately 45°, wherein the longitudinal axis 214 is expediently aligned coaxially with the axis of rotation 216.

The lower end 204 of the container 200 with respect to the direction of gravity g is designed to be open, so that the aperture opening 416 of the container 200 is formed, through which solar radiation 112 can enter the interior space 208 of the container 200.

To absorb the heat transferred by means of the solar radiation 112, the inner wall 218 of the container 200 is provided with a heat transfer medium 210, which is supplied via the inlet 300 through the feed opening 304 at the upper end 202 of the container 200.

Due to the rotation of the container 200 about the axis of rotation 216, the heat transfer medium 210 spreads on the inner wall 218 and thereby forms a heat transfer medium film 212.

The heat transfer medium 210 is fed into the interior space 208 of the container 200 via the inlet 300, which is arranged at the upper end 202 of the container 200.

The heat transfer medium 210 can be transported, in particular conveyed, along the inner wall 218 from the end 202 at which it is supplied to an end 204 of the container 200 opposite this end 202, on which the aperture opening 416 is arranged, in order to ensure a continuous flow of heat transfer medium 210 to be exposed to solar radiation 112 and thus heated.

The inlet 300 is formed from a conical front wall 302 and a conical rear wall 308 directed towards the interior space 208 of the container 200, which are arranged coaxially and one above the other in the axial direction. A cone angle can be, for example, between 30° and 90°, preferably between 45° and 80°.

Between the front wall 302 and the rear wall 308, guide elements 310 are arranged aligned in the radial direction 238, and are connected to the rear wall 308. In other exemplary embodiments, the guide elements 310 can also be connected to the inner wall 206 or overlapping alternately with the rear wall 308 and the inner wall 206. In the prior art, these guide elements 310 are straight.

The heat transfer medium 210 is introduced into the inlet 300 via a feed opening 304 arranged in a tip of the conical front wall 302 and is guided outwards between guide elements 310 in the radial direction 238 to the inner wall 218 of the container 200.

When the container 200 rotates in the direction of rotation 236, the heat transfer medium 210 is distributed on the inner wall 218 and guided downwards towards the outlet 400 by gravity g.

The inner wall 218 of the container 200 usually has a friction-promoting device 234 so that the heat transfer medium 210 adheres as well as possible to the inner wall 218 and thus has a sufficiently long permanence time in the interior space 208 to absorb enough heat from the solar radiation 112.

The heated heat transfer medium 210 is then available for further use, for example for generating electricity in the solar thermal power plant.

The heat transfer medium 210 can advantageously be flowable or free-flowing. In particular, the heat transfer medium 210 can be formed by particles.

In particular, it can be provided that the heat transfer medium 210 comprises particles of sintered bauxite or is formed from particles of sintered bauxite. The particles may preferably have an average particle diameter of about 250 μm to about 1.8 mm. However, powdered media with much smaller grain sizes, such as cement powder, can also be used. The heat carrier medium preferably results in no agglomeration of particles up to at least approximately 800° C., especially up to at least approximately 1,000° C. The particles preferably have a high sphericity. The sphericity, i.e. the ratio of the surface of a sphere of the same volume to the surface of the particle, can be in particular greater than approximately 0.8, in particular greater than approximately 0.9. Preferably the particles can be thermal shock resistant.

The axis of rotation can advantageously be parallel or at an acute angle of less than or equal to 90°, preferably less than or equal to 80°, to the direction of gravity g. In particular, the axis of rotation can be coaxial with the longitudinal axis of the container.

A heat transfer medium film 212 can be formed particularly favorably on the inner wall of the rotating container, so that the most uniform possible heat transfer to the heat transfer medium can be achieved.

The container can advantageously be made of steel. Due to the high temperatures of the heat transfer medium 210, the inner wall 218 is advantageously made of a high-temperature-resistant stainless steel or another high-temperature alloy such as Inconel.

Dimensions of the container 200 can, for example, be up to 8 m long and 5 m in diameter. The wall thickness of the inner wall 218 can be, for example, 6 mm, while the outer wall 206 can have a wall thickness of, for example, 12 mm. With such values, a weight of approximately 6 t up to 20 t can result for the container 200 with an associated thermal insulation between the inner wall 218 and the outer wall 206.

Ceramic fiber mats can advantageously be used as thermal insulation between the inner wall 218 and the outer wall 206. The outer wall 206 can additionally have thermal insulation made of microporous fibers, which can be pressed into plates, on an outer side 240.

With the specified dimensions, expansion values between the inner wall 218, which is heated to approximately 900° C. by the heat transfer medium 210, and the outer wall 206, which is at a temperature of approximately 100° C., can be up to 70 mm in the radial direction 238 and up to 150 mm in the longitudinal direction 215.

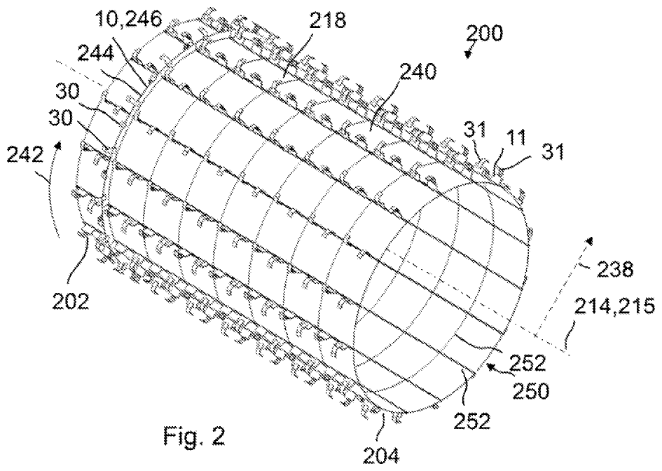

FIG. 2 shows an inner wall of the container 200 with support elements 10, 11 arranged thereon and counter support elements 30, 31 according to a first exemplary embodiment of the invention in an isometric view.

The container 200 has a double-walled housing 220 extending in a longitudinal direction 215, which surrounds an interior space 208 and has one outer wall 206 (not shown) and a surrounded inner wall 218, between which a large number of support elements 10, 11 and counter support 30, 31 is arranged.

Support elements 10, 11 and/or counter support elements 30, 31 corresponding with each other extend away from the outer wall 206 and/or the inner wall 218 in a radial direction. Support elements 10, 11 and counter support elements 30, 31 corresponding with each other are arranged in at least the longitudinal direction 215 or in the peripheral direction 242 along at least one peripheral line 244 being seated against each other on one side. Support elements 10, 11 or counter support elements 30, 31 are provided, which are seated on opposite sides of the corresponding counter support element 30, 31 or support element 10, 11.

Conveniently, some of the support elements 11 and the corresponding counter support elements 31 are thus arranged alternately on the inner wall 218 or the outer wall 206 in such a way that they act as floating supports which are movably arranged to each other in the radial 236 and axial direction 215 and block a relative movement in the peripheral direction 242.

A further part of the support elements 10 and the corresponding counter support elements 30 is arranged alternately on the inner wall 218 and the outer wall 206 in such a way that they act as a further floating support and are movably arranged to each other in the radial 236 and peripheral direction 242 of the container 200 and block a relative movement in the longitudinal direction 215 of the container 200.

The two floating supports act perpendicular to each other. The interaction of the two types of floating supports, especially in the same location, form a fixed support. This allows a relative movement of the support elements 10, 11 and counter support elements 30, 31 in the radial direction 236, but blocks it in the peripheral direction 242 and in the longitudinal direction 215.

In this way, rotation of the inner wall 218 about the longitudinal axis 215 against the outer wall 206 is blocked in the region of the support elements 10, 11 and corresponding counter support elements 30, 31 arranged as floating supports.

A fixed support can be provided, for example, in a peripheral region of the container 200, for example closer to one end of the container 200. In the region of the support elements 10 arranged as a further floating support and corresponding counter support elements 30, which form a fixed support with the first type of floating support, a relative movement of the inner wall 218 against the outer wall 206 in the longitudinal direction 215 as well as a rotation of the inner wall 218 about the longitudinal axis 215 against the outer wall 206 is blocked on a peripheral line 244.

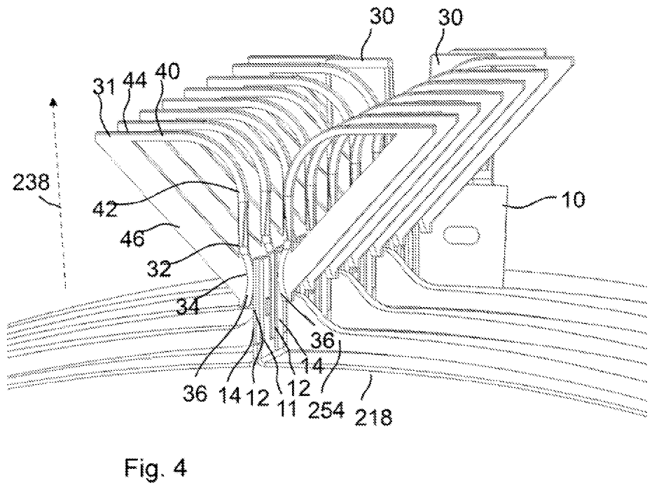

The support elements 10, 11 are designed as fins projecting in the radial direction 238 to the outer wall 206, which have at least one contact surface 12 facing a corresponding counter support element 30 in the peripheral direction 242, as can be seen in FIG. 4.

The counter support elements 30, 31 are designed as fins projecting in the radial direction 238 to the inner wall 206, which fins have at least one contact surface 34 facing the respective corresponding support element 30 in the peripheral direction 242. The counter support elements 30, 31 can be screwed to the outer wall 206, for example. In a first exemplary embodiment, as shown in FIG. 2, the counter support elements 30, 31 can be designed as bent fins.

A floating support of the inner wall 218 relative to the outer wall 206 can be achieved by arranging individual fins of this type on the inner wall as support elements 11 over the circumference 242 of the inner wall 218. These fins can, for example, be drawn over the entire axial length 215 or can be arranged individually, divided several times over the axial length 215. These fins serve as a sliding surface in the radial and axial directions. Drivers 32 can be arranged alternately on the sliding surfaces in the axial direction, which drivers are attached to the outer wall 206 as counter support elements 31. Such an arrangement can also be provided reciprocally in the peripheral direction. However, this is not absolutely necessary.

The driver 32 with its contact surface 34 represents the active element of the counter support element 30, 31 for interaction of the support element 10, 11 and the counter support element 30, 31, to limit the relative movement of the inner wall 218 against the outer wall 206. By means of the driver 32, the counter support element 30, 31 is seated on the support element 10, 11 via its contact surface 34.

Since the floating support is arranged flat in this way, its functionality for blocking rotation of the inner wall 218 against the outer wall 206 in the peripheral direction 242 is automatically also provided in the region of the fixed support. Consequently, it is sufficient if movement on the fixed support is only blocked in the longitudinal direction 215. The implementation can take place in such a way that, for example, a web, like a kind of stiffening ring 246, is arranged over the circumference of the inner wall 218. This ring 246 can again be designed in the form of several individual fins, but this time oriented in the peripheral direction. The ring 246 again serves as a sliding surface, this time only in the peripheral direction 242.

Counter support elements 30 can be arranged to slide alternately on this ring 246 over the circumference, so that axial movement of the inner wall 218 against the outer wall 206 is hindered. The counter support elements 30 are also connected to the outer wall 206.

However, for a fixed support in the longitudinal direction 215, a one-sided attachment of the counter support elements 30 in the direction of gravity can also be sufficient. The construction in the so-called fixed support region can therefore be made more compact.

The counter support elements 30, 31 can be designed as sheet metal strips bent at right angles, wherein one leg is connected to the outer wall 206 and the other leg is seated against the support element 10, 11.

A peripheral ring 246 is formed along the peripheral line 244 and is arranged radially between the outer wall 206 and the inner wall 218 and has or forms at least one support element 10. The ring 246 is arranged on the inner wall 218 in this exemplary embodiment.

The inner wall 218 is formed from individual longitudinal segments 250 joined together in the peripheral direction 242, in particular longitudinal segments 250 arranged in a ring shape in the peripheral direction 242 and stacked in the longitudinal direction 215. The longitudinal segments 250 are divided into axial segments 260 in the longitudinal direction 215.

By dividing the inner wall 218 into individual longitudinal segments 250 and/or axial segments 260, large dimensions of the container 200 can be achieved inexpensively.

In particular, the integration of the support elements 10, 11 into the longitudinal segments 250 and/or axial segments 260 by folding the longitudinal segments 250 and/or axial segments 260 enables cost-effective production of the container 200. In addition, a firm connection of the support elements 10, 11 to the inner wall 218 can be ensured in a simple manner.

The support elements 11 are each arranged in the longitudinal direction 215 on the inner wall 218 and interact with the corresponding counter support elements 31 arranged on the outer wall 206. The support elements 11 and the corresponding counter support elements 31 form the floating support between the inner wall 218 and the outer wall 206.

The support elements 10 are each arranged in the peripheral direction 242, in this exemplary embodiment as a ring 246, on the inner wall 218 and cooperate with the corresponding counter support elements 30 arranged on the outer wall 206. The support elements 10 and the corresponding counter support elements 30, in combination with the support elements 11 and counter support elements 31, form the fixed support between the inner wall 218 and the outer wall 206.

The floating supports block a relative movement in the peripheral direction 242. The fixed support blocks relative movement in the peripheral direction 242 and in the longitudinal direction 215.

In this way, rotation of the inner wall 218 about the longitudinal axis 214 against the outer wall 206 is blocked in the region of the support elements 11 and corresponding counter support elements 31 arranged as floating supports.

In the region of the support elements 10 and corresponding counter support elements 30, a relative movement of the inner wall 218 against the outer wall 206 in the longitudinal direction 215 as well as a rotation of the inner wall 218 about the longitudinal axis 214 against the outer wall 206 is blocked on a peripheral line 244.

Differences in expansion between the inner wall 218 and the outer wall 206 can advantageously be compensated for by the support construction possible using the support elements and counter support elements according to the invention. At the same time, it is ensured that the inner wall 218 has the same axis of rotation 216 as the outer wall 206 and does not slip through the outer wall 206 in the longitudinal direction 215.

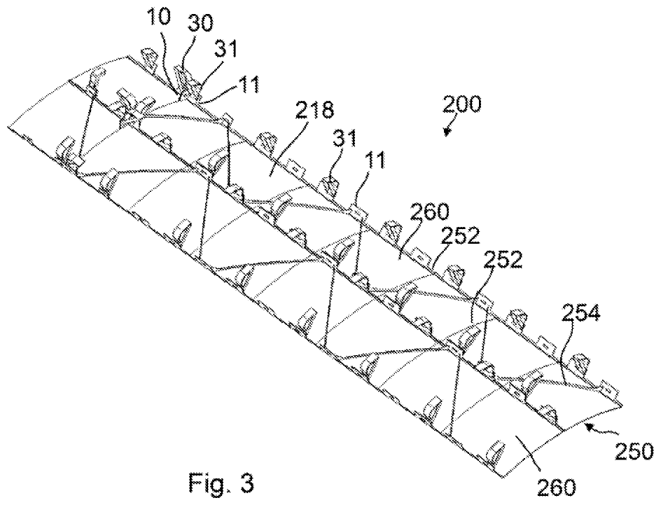

FIG. 3 shows an enlarged detail of an inner wall 218 of the container with support elements 10, 11 arranged thereon and counter support elements 30, 31 according to a second exemplary embodiment of the invention in an isometric view, while FIG. 4 shows a detail of a series of support elements 10, 11 and counter support elements 30, 11 according to the second embodiment of the invention from FIG. 3.

The counter support elements 30, 31 have two legs 40, 42, which are arranged in particular at right angles to one another. One of the two legs 40 has a connecting surface 44 with the outer wall 206 and the other of the two legs 42 has the contact surface 34.

The counter support elements 30, 31 have a driver 32 which projects in the radial direction 238 and which has at least one contact surface 34 facing a corresponding support element 10. The driver 32 is formed by the second leg 42.

In this exemplary embodiment, the two legs 40, 42 are connected by a strut 46 arranged diagonally between ends of the legs 40, 42. The strut can serve as additional stiffening of the counter support element 30, 31 in order to be able to transmit larger forces between the support element 10, 11 and the counter support element 30, 31. The forces that have to be transmitted can be up to 10 kN per counter support element 30, 31 for the specified dimensions of the container 200.

The contact surface 34 of the counter support element 31 has a sliding element 36, for example a ceramic plate, the surface of which is concave relative to the contact surface 12 of the support element 11.

The concave curved surface of the sliding element 36 facilitates assembly of the container 200 by self-centering support elements 10, 11 and counter support elements 30, 31, in this way. In addition, movements of the inner wall 218 against the outer wall 206 due to thermal expansion, which can lead to shrinking and growing of the diameter of the inner wall 218, can be promoted.

Additional ceramic plates can be installed on the contact surfaces 12, 34 to protect the material. This means that the abrasion of the material due to the movement of the support elements 10, 11 and counter support elements 30, 31 due to the thermal expansion can be significantly reduced.

The sliding element 14, 36 can also act as thermal insulation.

Ceramic plates, for example made of Al₂O₃, SiC, ZrO₂, can be used as the material for the sliding elements 14, 36. Since the sliding elements 14 of the support elements 10, 11 slide on the sliding elements 36 of the counter support elements 30, 31, a ceramic-ceramic sliding combination is advantageously used as a combination.

The longitudinal segments 250 and/or axial segments 260 have stiffening ribs 254, in particular diagonally extending stiffening ribs 254, on a radial outer side 240.

Through the stiffening ribs 254, the mechanical stability of the inner wall 218 can be significantly increased. This means that large dimensions of the container 200 can be advantageously implemented while having a moderate increase in weight of the receiving device 110.

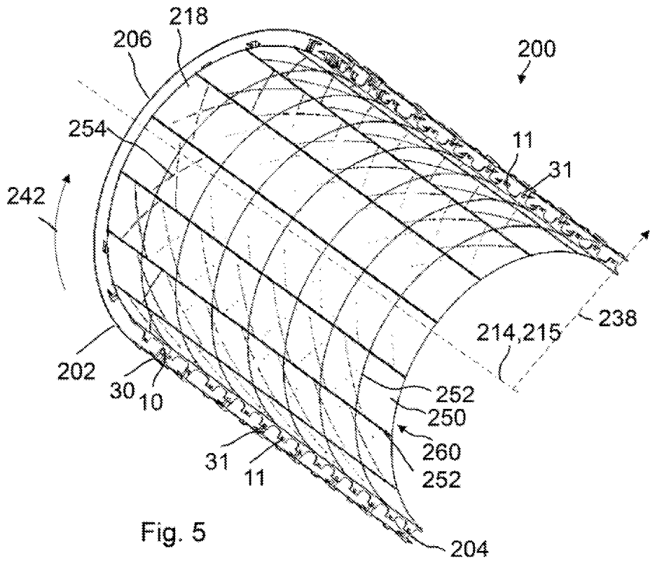

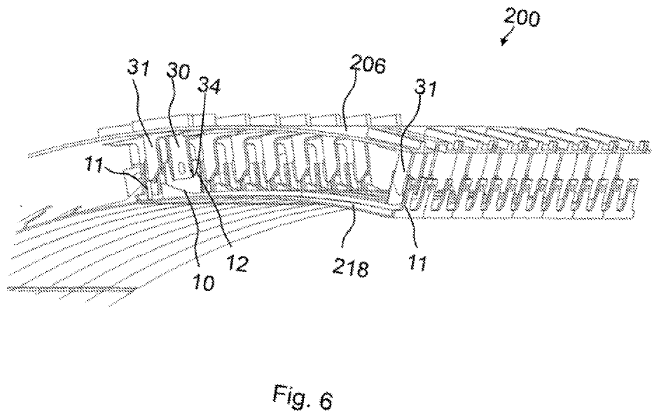

FIG. 5 shows a container 200 with inner wall 218 and outer wall 206 according to a third exemplary embodiment of the invention in a cut isometric view, while in FIG. 6 an enlarged detail of the container 200 according to FIG. 5 from the region between inner wall 218 and outer wall 206 is shown.

In this third exemplary embodiment, the two legs 40, 42 of the counter support element 30, 31 are designed as U-profiles. This means that the strut 46, which is arranged in the second exemplary embodiment for reasons of stability, can be omitted. The design as a U-profile can advantageously serve to be able to transmit larger forces between the support element 10, 11 and the counter support element 30, 31. In addition, the counter support elements 30, 31 can be manufactured cost-effectively.

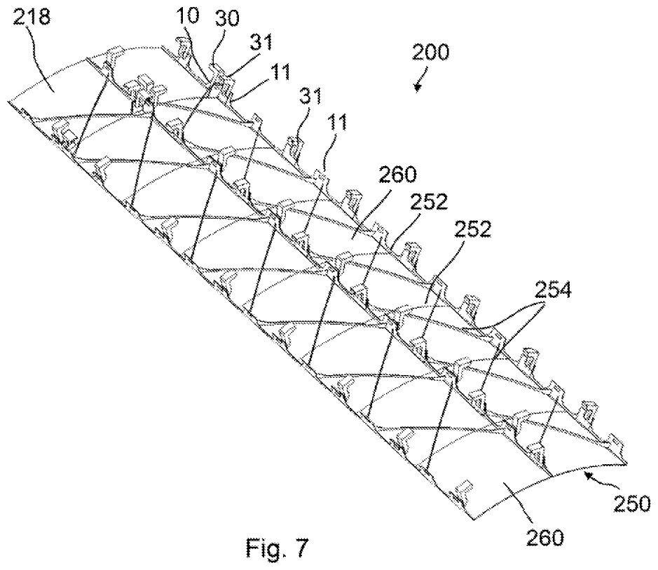

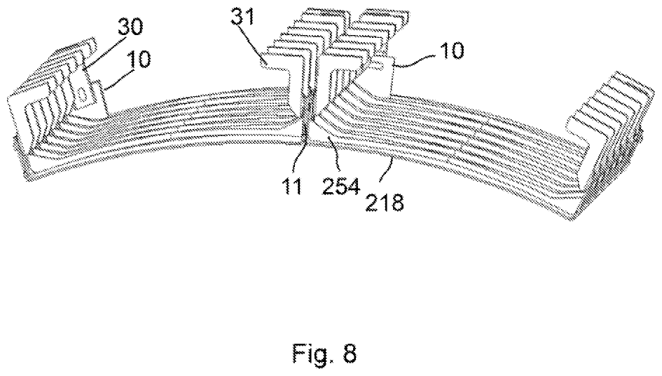

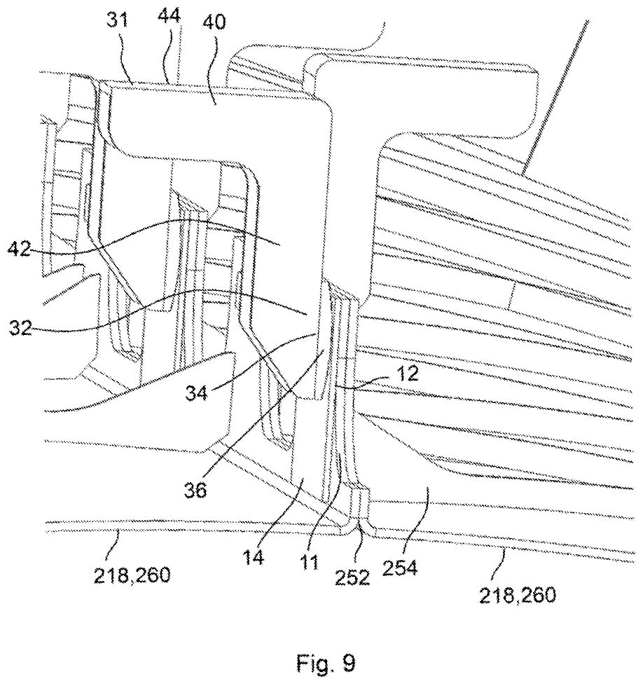

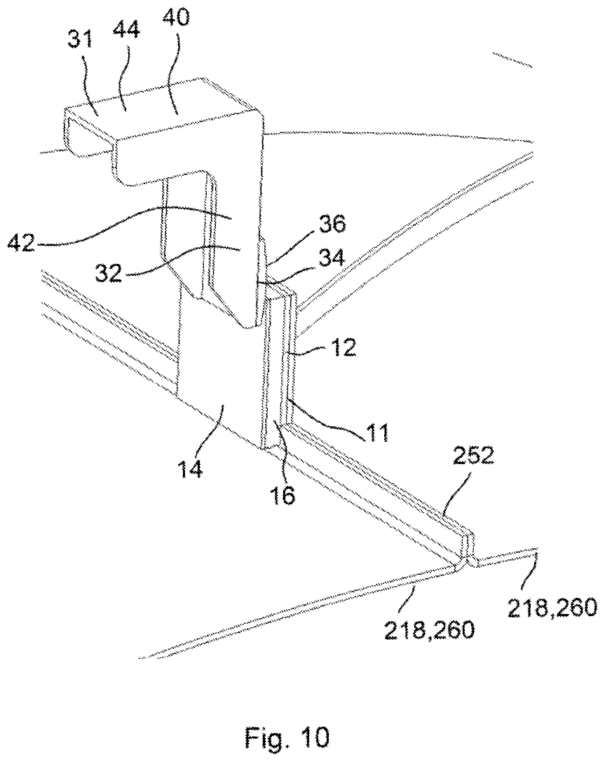

FIG. 7 shows an enlarged detail of an inner wall 218 of the container 200 with support elements 10, 11 arranged thereon and counter support elements 30, 31 according to the third exemplary embodiment of the invention in an isometric view; FIG. 8 shows a detail of a series of support elements 11 and counter support elements 31 according to the third exemplary embodiment of the invention. FIG. 9 shows an enlarged view of the third exemplary embodiment according to FIG. 8 with a view of sliding elements 14, 36, while FIG. 10 shows an enlarged representation of the third exemplary embodiment, with view on the sliding elements 14, 36 and insulating elements 16.

Intermediate layers as thermal insulation between the sliding element 14, 36 and the support elements 10, 11 or counter support elements 30, 31 can significantly reduce the heat transfer from the inner wall 218 to the outer wall 206. This makes it possible to maintain the lower temperatures required on the outer wall 206. The thermal loss of the receiving device 110 can also be reduced to a required level in a favorable manner.

In FIGS. 9 and 10 in particular, it can be seen that the support elements 10, 11 are formed in one piece with the longitudinal segments 250, namely in that the support elements 10, 11 are formed by folding the longitudinal segments 250 along joining lines 252 of the longitudinal segments 250 relative to one another.

A sliding element 14, in particular made of ceramic, is arranged between at least one support element 10, 11 and the corresponding counter support element 30, 31. In particular, the sliding element 14 is arranged on the support element 10, 11, namely on the contact surface 12, while on the contact surface 34 of the driver 32 a sliding element 36, in particular also made of ceramic, is arranged, which faces the corresponding support element 10, in particular the respective sliding element 14. The sliding element 36 has a surface that faces the respective corresponding sliding element 14 and is concavely curved in the radial direction 238.

As can be seen in FIG. 10, an insulating element 16 for thermal insulation is arranged between the sliding element 14 and the contact surface 12. Ceramic fiber mats can advantageously be used as insulating elements 16.

FIG. 11 shows an enlarged view with a view of a fastening element 18 of a sliding element 36 on a support element 31 arranged on the inner wall 218.

The sliding element 14 of the support element 11 is connected to the respective support element 11 by means of a fastening element 18, which is designed in particular as a fastening spring 18. The fastening spring 18 passes through an opening 22 in the support element 11.

Sliding elements 14, 36 and/or insulating elements 16 can thus be reliably and permanently connected to the support element 10, 11 or counter support element 30, 31 by means of a fastening according to a tongue and groove concept. Due to the thermal expansion of the inner wall 218 and the outer wall 206, shearing forces can also be conveniently absorbed between each other.

The sliding elements 36 and insulating elements 16 can also be connected to the counter support elements 30, 31 or the support elements 10, 11 in the same way.

In the exemplary embodiment shown in FIG. 11, an additional thermal insulating element 16 is arranged between the contact surface 34 and the sliding element 36 of the counter support element 31.

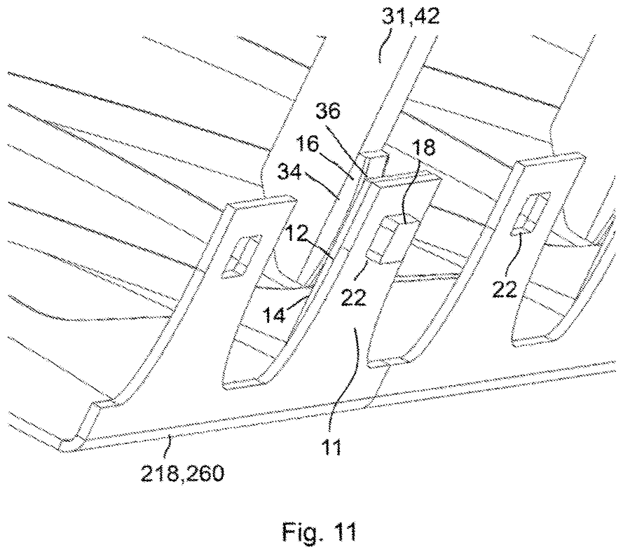

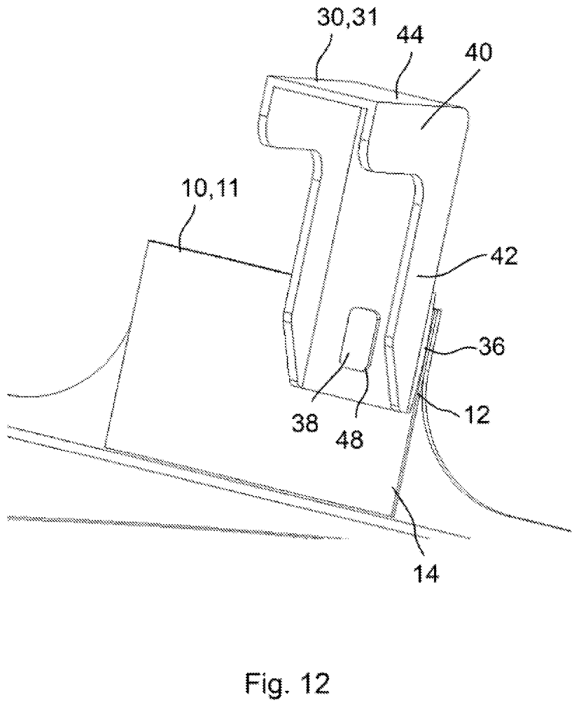

FIG. 12 shows an enlarged view with a view of a fastening spring 38 of a sliding element 36 on a counter support element 30, 31. The fastening spring 38 engages through a corresponding opening 48 in the second leg 42 of the counter support element 30, 31.

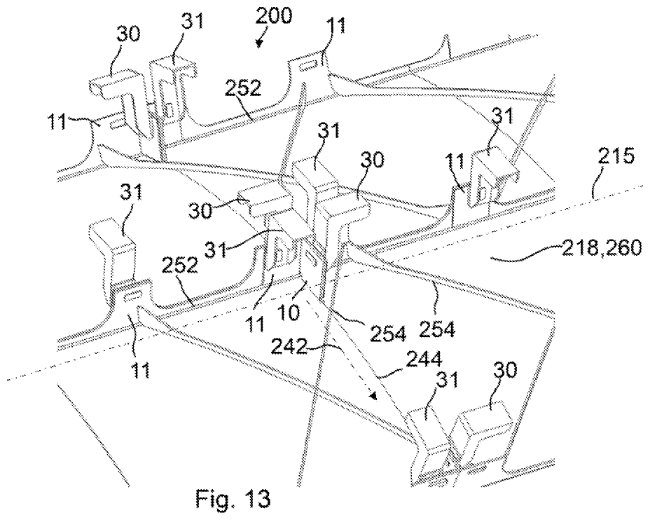

In FIG. 13, an arrangement of support elements 10, 11 and counter support elements 30, 31 of the third exemplary embodiment, designed as a fixed support, is shown in an isometric view.

In this illustration, the support elements 11 arranged in the longitudinal direction 214 can be seen with their corresponding counter support elements 31, which form the floating support. In the peripheral direction 242, on the other hand, the support elements 10 with their corresponding counter support elements 30 can be seen, which form the fixed support with the support elements 11 with their corresponding counter support elements 31.

At intersection points of the peripheral line 244 with the joining lines 252 of the longitudinal segments 250 or the axial segments 260 running in the longitudinal direction 215, two support elements 10 with counter support elements 30 and two support elements 11 with counter support elements 31 are arranged interleaved in such a way that a fixed support is formed and a relative movement of the inner wall 218 against the outer wall 206 in the longitudinal direction 215 and in the peripheral direction 242 is prevented.

In this illustration, the stiffening of the axial segments 260 by the diagonal struts 254 can also be seen.

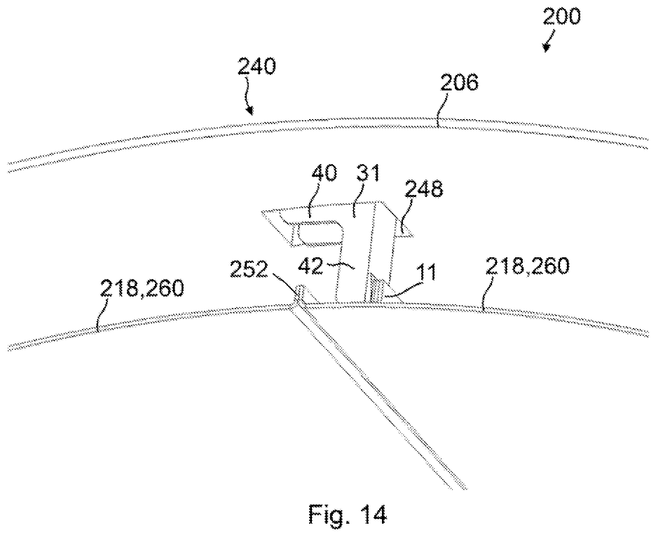

FIG. 14 shows an arrangement of a counter support element 31 of the third exemplary embodiment on the outer jacket 206. One leg 40 of the counter support element 31 is passed through a window 248 arranged in the outer wall 206 and can be connected to the outer wall 206 from the outside.

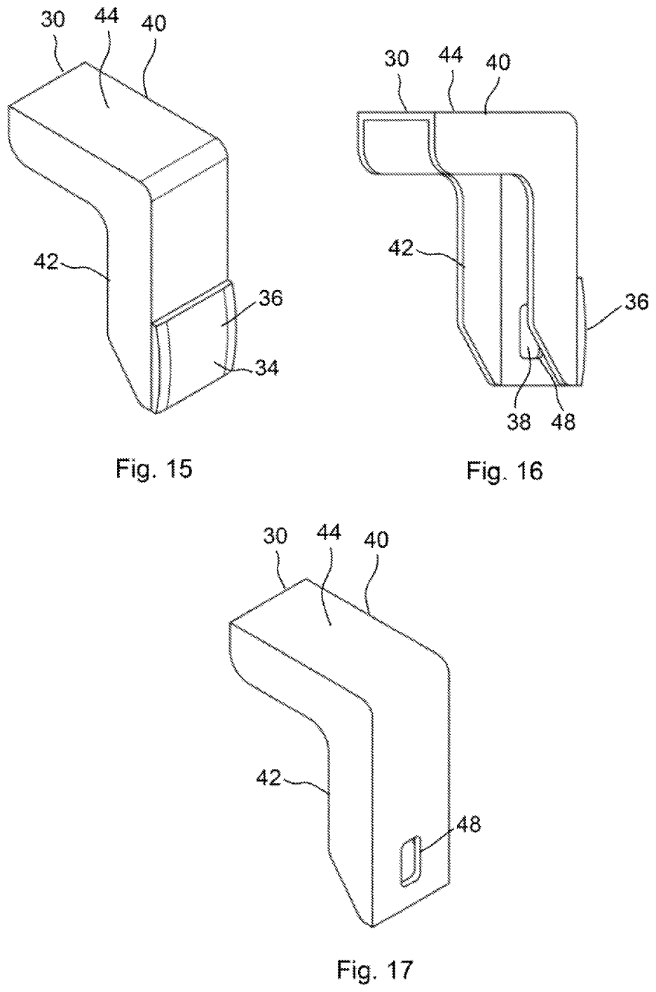

FIG. 15 shows a counter support element 30 according to the third exemplary embodiment of the invention in an isometric view with a view of the sliding element 36, while in FIG. 16 the counter support element 30 with a view of the fastening spring 38 of the sliding element 36 and in FIG. 17 the counter support element 30 without the sliding element 36 is shown.

FIG. 16 shows how the fastening spring 38 of the sliding element 36 is passed through the opening 48 in the second leg 42 of the counter support element 30. In FIG. 17, on the other hand, only the opening 48 in the second leg 42 can be seen.

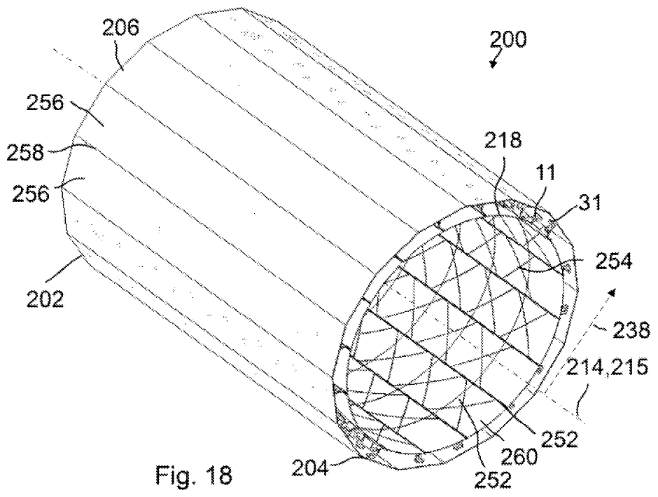

FIG. 18 shows a container 200 with a polygon-shaped outer jacket 206 according to a further exemplary embodiment of the invention. The outer wall 206 is formed from flat longitudinal segments 256, which are joined along joining lines 258 formed in the longitudinal direction 215.

A polygonal outer shape of the outer wall 206 can prove to be particularly advantageous in order to have flat surfaces on the outer side 240 of the container 200 for connecting the counter support elements 30, 31. For example, the counter support elements 30, 31 can be mounted through a type of removable window 248, as can be seen in FIG. 14.

The advantage of constructing the outer wall 206 from flat longitudinal segments is that many simple identical parts can be used. Since the support is sliding and therefore has several parts, assembly and subsequent maintenance are significantly simplified. Furthermore, the components are subject to a significantly lower load, as there will be no constant deformation due to sliding, in contrast to a version with a double spring. This means that large thermal deformation paths are possible without any problems.

A polygonal-shaped outer wall 206 has the advantage that mechanical connections are possible in a simpler way. This also favors a multi-part structure for large containers 200.

### LIST OF REFERENCE NUMERALS

10 support element
11 support element
12 contact surface
14 sliding element
16 insulating element
18 fastening element
20 fastening element
22 through opening
30 counter support element
31 counter support element
32 driver
34 contact surface
36 sliding element
38 fastening element
40 leg
42 leg
44 connection surface
46 strut
48 through opening
110 receiving device
112 solar radiation
200 container
202 first end
204 second end
206 outer wall
208 interior space
210 heat transfer medium
212 heat transfer medium film
214 longitudinal axis
215 longitudinal direction
216 axis of rotation
218 inner wall
220 housing
222 angle
236 direction of rotation
238 radial direction
240 outer side
242 peripheral direction
244 peripheral line
246 ring
248 window
250 longitudinal segment
252 joining line
254 stiffening rib
256 longitudinal segment
258 joining line
260 axial segment
300 inlet
302 front wall
304 feed opening
308 back wall
310 guide element
400 outlet
416 aperture opening

1. A receiving device for solar radiation with a container for heating a heat transfer medium in a solar thermal power plant,
comprising
a double-walled housing which extends in a longitudinal direction, the housing surrounding an interior and having an outer wall and an inner wall surrounded by the outer wall, between which a plurality of support elements and counter support elements is disposed,
wherein support elements and/or counter support elements corresponding with each other extend away from the outer wall and/or the inner wall in a radial direction and
wherein support elements and counter support elements corresponding with each other in at least the longitudinal direction are seated against each other on one side; and
support elements and counter support elements corresponding with each other in the peripheral direction along at least one peripheral line are seated against each other on one side,
wherein at least two support elements are provided which are seated against opposite sides of the corresponding counter support element and/or
wherein at least two support elements are provided which are seated against opposite sides of the corresponding support element.

2. The receiving device according to claim 1, wherein the support elements are designed as fins projecting in the radial direction to the outer wall, which have at least one contact surface facing a corresponding counter support element in the peripheral direction
and/or
wherein the counter support elements are designed as fins projecting in the radial direction to the inner wall, which have at least one contact surface facing the respective corresponding support element in the peripheral direction.

3. The receiving device according to claim 1, wherein a sliding element is arranged between at least one support element and the corresponding counter support element.

4. The receiving device according to claim 3, wherein an insulating element for thermal insulation is arranged between the sliding element and the contact surface.

5. The receiving device according to claim 1, wherein the counter support elements have a driver which projects in the radial direction and which has at least one contact surface facing a corresponding support element.

6. The receiving device according to claim 5, wherein a sliding element, is arranged on the contact surface of the driver, which sliding element faces the corresponding support element.

7. The receiving device according to claim 3, wherein at least one of the sliding elements has a concavely curved surface in the radial direction facing the respective corresponding sliding element.

8. The receiving device according to claim 5, wherein the counter support elements have two legs, wherein one of the two legs has a connecting surface with the outer wall and the other of the two legs has the contact surface.

9. The receiving device according to claim 8, wherein the two legs of the counter support element are connected by a strut.

10. The receiving device according to claim 8, wherein the two legs of the counter support element are designed as U-profiles.

11. The receiving device according to claim 3, wherein the sliding elements and/or the insulating element are connected by means of at least one fastening element to the respective support element or the respective counter support element.

12. The receiving device according to claim 1, wherein a peripheral ring arranged radially between the outer wall and the inner wall is formed along the peripheral line, which ring has or forms at least one support element.

13. The receiving device according to claim 1, wherein the inner wall is formed from individual longitudinal segments joined together in the peripheral direction, wherein the support elements are formed in one piece with the longitudinal segments.

14. The receiving device according to claim 13, wherein the longitudinal segments are divided into axial segments in the longitudinal direction.

15. The receiving device according to claim 13, wherein the longitudinal segments and/or axial segments have stiffening ribs on a radial outer side.

16. The receiving device according to claim 1, wherein at least the outer wall is formed from flat longitudinal segments which are joined at least along joining lines formed in the longitudinal direction.

17. The receiving device according to claim 1, comprising
an aperture opening for the entry of solar radiation at one of the ends of the container;
wherein the container has a longitudinal axis which is oriented parallel or at an acute angle less than or equal to 90° to the direction of gravity, wherein the container is rotated in a intended direction of rotation by means of a rotary drive device about an axis of rotation so that the heat transfer medium can be guided along an inner wall of the container to form a heat transfer medium film.
